(19) United States
(12) Patent Application Publication
(10) Pub. No.: US 2007/0211010 A1
(43) Pub. Date: Sep. 13, 2007

(54) DISPLAY SYSTEM CAPABLE OF AUTOMATIC DE-SKEWING AND METHOD OF DRIVING THE SAME

(76) Inventor: Che-Li Lin, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/383,227

(22) Filed: May 15, 2006

(30) Foreign Application Priority Data
Mar. 10, 2006 (TW) 095108178

(51) Int. Cl. G09G 3/36

(52) U.S. Cl. 345/99

(57) ABSTRACT

A display system generates a plurality of sampling signals each having distinct phases based on external clock signals provided by a timing controller, latches data from external data signals provided by the timing controller based on the sampling signals, and sends the latched data to a decoder for determining a best sampling signal. Each driver of the display system generates driving voltages based on a respective best sampling signal determined by a respective decoder.

### BACKGROUND OF THE INVENTION

1. Field of the Invention

The present invention relates to a display system and method of driving the same, and more particularly, to a display system capable of automatic de-skewing and method of driving the same.

2. Description of the Prior Art

Liquid crystal display (LCD) devices are flat panel displays characterized by thin appearance, low radiation and low power consumption. LCD devices have gradually replaced traditional cathode ray tube (CRT) displays, and been widely applied in various electronic products such as notebook computers, personal digital assistants (PDAs), flat panel televisions, or mobile phones.

An LCD device usually includes an LCD panel, a timing controller, a gate driver, and a source driver. The timing controller generates data signals corresponding to display images, together with control signals and clock signals for driving the LCD panel. The source driver generates driving signals based on the data signals, the control signals and the clock signals received from the timing controller. For displaying images correctly, various signals are transmitted from the timing controller to the source drivers via an interface. Common interfaces used in an LCD device include transistor-transistor logic (TTL) interfaces, reduced swing differential signal (RSDS) interfaces, low voltage differential signal (LVDS) interfaces, and mini low voltage differential signal (mini-LVDS) interfaces, etc. Regardless of the type of the interface used in the LCD device, the data setup time and data stable time of the data signals, the control signals and the clock signals have to be properly designed so that the source drivers can access data accurately and generate correct driving signals for the LCD panel.

With increasing demand for large-size and high-resolution applications in flat panel displays, the size of LCD panels, the number of source drivers, and the size of signal transmission media (such as printed circuit boards) also increase accordingly. Therefore, the signal transmission path between a timing controller and a source driver becomes longer. At the same time, as the circuit layout varies, the length of signal transmission paths from a timing controller to different source drivers can also be different, resulting in unmatched toggle rates, ground shielding, and output driving capabilities for different source drivers. Therefore, different source drivers receive signals having different degrees of signal delays, causing phase difference variations between different signals, such as between the data and control signals, between the data and clock signals, or between the control and clock signals. These kinds of variations, known as signal skews, can restrain the source drivers from correctly accessing data and influence the display quality of the LCD display, especially in high frequency applications.

Reference is made to FIG. 1 for a functional block diagram of a prior art LCD device 10. The LCD device 10 includes a timing controller 12, a plurality of source drivers, and an LCD panel 16. For ease of explanation, only one source driver 14 is illustrated in FIG. 1. Other source drivers of the LCD device 10 have the same structure as that depicted in FIG. 1. The timing controller 12 generates an external data signal EXT_{DATA} and an external clock signal EXT_{CLK}, which are then transmitted to the source driver 14 for generating a driving signal V_{DRIVE} for the LCD panel 16. The LCD panel 16 can then display images according to the driving signal V_{DRIVE}.

Reference is made to FIG. 2 for a signal diagram illustrating the operation of the prior art LCD device 10. FIG. 2 illustrates the phase relationship between the external data signal EXT_{DATA} and the external clock signal EXT_{CLK}. The data setup time, designated as T_{SETUP}, refers to the required wait time after the external data signal EXT_{DATA} changes level until the external data signal EXT_{DATA} can be correctly sampled by the external clock signal EXT_{CLK}. The data stable time, designated as T_{STABLE}, refers to the time period during which the external data signal EXT_{DATA} can be correctly sampled by the external clock signal EXT_{CLK}. In the prior art LCD device 10, the data setup time T_{SETUP} and the data stable time T_{STABLE} are fixed. Due to various circuit layouts or other reasons, the external data signal EXT_{DATA} and the external clock signal EXT_{CLK} received by different source drivers may encounter different degrees of signal delay. The relationship between the data setup time T_{SETUP} and the data stable time T_{STABLE} can deviate from that shown in FIG. 2.

In the prior art LCD device 10, the phase relationship, the data setup time T_{SETUP}, and the data stable time T_{STABLE} of the external data signal EXT_{DATA} and the external clock signal EXT_{CLK} are fixed. Due to unmatched toggle rates, ground shielding, and output driving capabilities, different source drivers may receive the external data signals EXT_{DATA} and the external clock signals EXT_{CLK} having different degrees of signal delay. Under such circumstance, the prior art LCD decide 10 cannot adjust signal skews and the display quality is thus influenced.

### SUMMARY OF THE INVENTION

The claimed invention provides a display system capable of automatic de-skewing and includes a display panel for displaying images, a timing controller for generating an external data signal and an external clock signal, an automatic adjusting circuit coupled to the timing controller for adjusting phases of the external data signal and the external clock signal and thereby generating a corresponding internal data signal and a corresponding internal clock signal having signal triggering edges aligned to ranges of the internal data signal where data can be correctly sampled, and a driving circuit coupled to the automatic adjusting circuit and the display panel for generating driving voltages for the display panel based on the internal data signal and internal clock signal received from the automatic adjusting circuit.

The claimed invention also provides a driving method capable of automatic de-skewing including (a) receiving an external data signal and an external clock signal, (b) generating a plurality of sampling signals by adjusting a phase of the external clock signal, (c) generating a plurality of corresponding data latch signals by sampling the external data signal based on the plurality of sampling signals, (d) selecting a best sampling signal from the plurality of the sampling signals based on the plurality of data latch signals, and (e) outputting the best sampling signal as an internal clock signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a prior art LCD device.

FIG. 2 is a signal diagram illustrating the operation of the prior art LCD device in FIG. 1.

FIG. 3 shows a functional block diagram of an LCD device according to a first embodiment of the present invention.

FIG. 4 shows a functional block diagram of an LCD device according to a second embodiment of the present invention.

FIG. 5 is a diagram of the automatic adjusting circuit according to the present invention.

FIGS. 6-21 are waveforms illustrating the driving methods according to the present invention.

FIG. 22 is a truth table for automatic de-skewing according to the present invention.

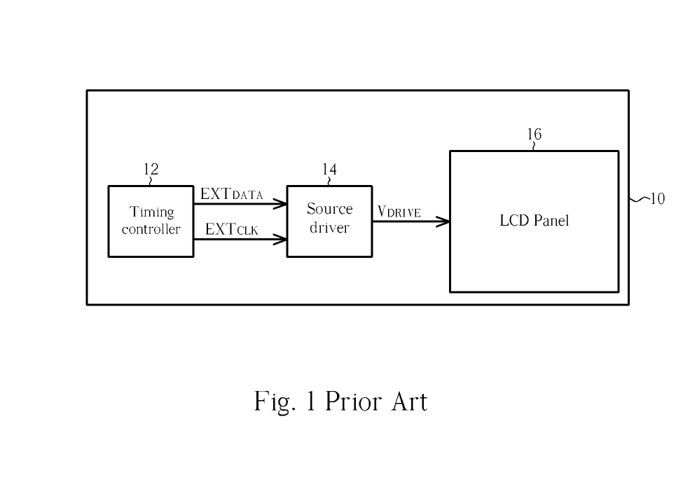

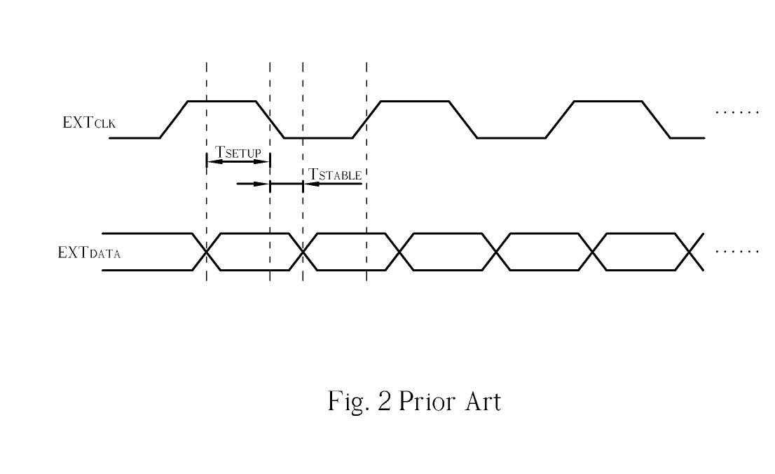

### DETAILED DESCRIPTION

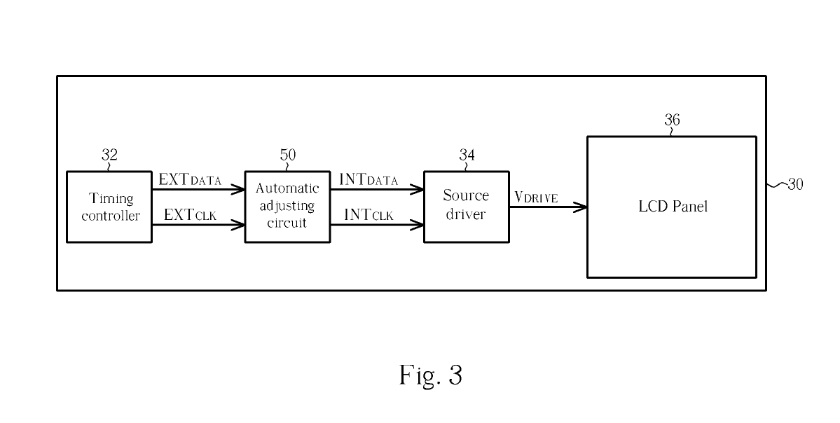

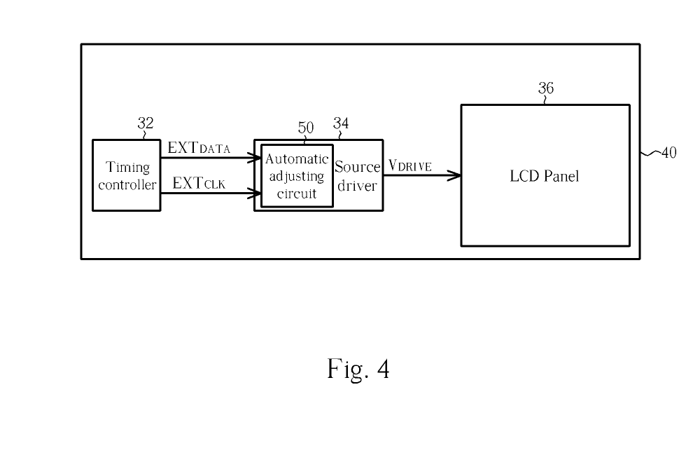

Please refer to FIGS. 3 and 4. FIG. 3 shows a functional block diagram of an LCD device 30 according to a first embodiment of the present invention, and FIG. 4 shows a functional block diagram of an LCD device 40 according to a second embodiment of the present invention. The LCD devices 30 and 40 each include a timing controller 32, a plurality of source drivers 34, an LCD panel 36, and an automatic adjusting circuit 50. For ease of explanation, only one source driver 34 is depicted in FIGS. 3 and 4. Other source drivers of the LCD devices 30 and 40 have the same structure as that depicted in FIGS. 3 and 4. In the first embodiment of the present invention, the automatic adjusting circuit 50 and the source driver 34 of the LCD device 30 are two independent integrated circuits (IC). In the second embodiment of the present invention, the automatic adjusting circuit 50 and the source driver 34 of the LCD device 40 are integrated as a same IC.

In the LCD devices 30 and 40, the timing controller 32 generates an external data signal EXT_{DATA} and an external clock signal EXT_{CLK}, which are then transmitted to the automatic adjusting circuit 50. The data setup time, data stable time and the phase relationship between the external data signal EXT_{DATA} and the external clock signal EXT_{CLK} are predetermined. In an ideal case, each source driver 34 can generate a correct driving signal for the LCD panel 36 based on the external data signal EXT_{DATA} and the external clock signal EXT_{CLK}. However in reality, the phase differences between the external data signals EXT_{DATA} and the external clock signals EXT_{CLK} received by different source drivers can deviate from the predetermined value. When the deviation is too large, data cannot be correctly accessed. Therefore, the automatic adjusting circuit 50 of the present invention generates an internal data signal INT_{DATA} and a best internal clock signal INT_{CLK} by adjusting the phase difference between the external data signal EXT_{DATA} and the external clock signal EXT_{CLK}, so that signal triggering edges of the best internal clock signal INT_{CLK} are aligned to ranges of the internal data signal INT_{DATA} where data can be correctly sampled. As a result, the source driver 34 can generate a driving signal V_{DRIVE} for the LCD panel 36 based on the internal data signal INT_{DATA} and the best internal clock signal INT_{CLK}.

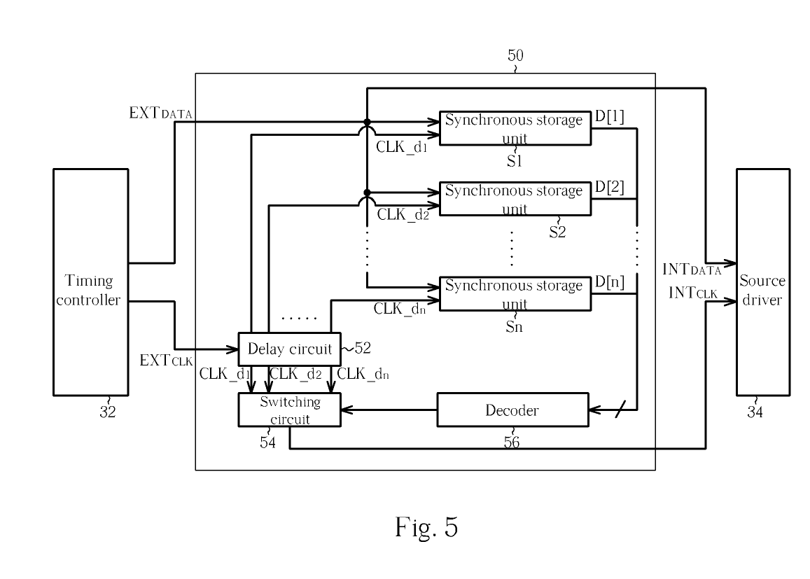

Reference is made to FIG. 5 for a diagram of the automatic adjusting circuit 50 in the LCD device 30. The automatic adjusting circuit 50 includes a delay circuit 52, a plurality of synchronous storage units S1-Sn, a switching circuit 54, and a decoder 56. The delay circuit 52 receives the external clock signal EXT_{CLK} from the timing controller 32 and generates a plurality of sampling signals CLK_d1-CLK_dn having distinct phases by adjusting the phase of the external clock signal EXT_{CLK}. The sampling signals CLK_d1-CLK_dn are then sent to the switching circuit 54, and respectively to the synchronous storage units S1-Sn. The phase relationship between the sampling signals CLK_d1-CLK_dn and the external clock signal EXT_{CLK} will be described in more detail in the following paragraphs.

The synchronous storage units S1-Sn, coupled to the timing controller 32 and the delay circuit 52, receive the external clock signal EXT_{CLK} from the timing controller 32 and respectively receive the sampling signals CLK_d1-CLK_dn from the delay circuit 52. The synchronous storage units S1-Sn latch data from the external data signal EXT_{DATA} at the signal triggering edges of the sampling signals CLK_d1-CLK_dn, respectively. Afterwards, data latch signals D[1]-D[n] corresponding to the data latched from the external data signal EXT_{DATA} are sent to the decoder 56. The signal triggering edges of the sampling signals CLK_d1-CLK_dn can be the signal rising edges or the signal falling edges. Since the sampling signals CLK_d1-CLK_dn have distinct phases, the values of the data latch signals D[1]-D[n] are also different. Therefore, the decoder 56 can determine a best sampling signal from the sampling signals CLK_d1-CLK_dn based on the values of the data latch signals D[1]-D[n]. Among the sampling signals CLK_d1-CLK_dn, the phase difference between the best sampling signal and the external data signals EXT_{DATA} best approximates the predetermined value. In other words, the external data signal EXT_{DATA} can be sampled most accurately based on the best sampling signal. Subsequently, the decoder 56 generates a switch control signal corresponding to the best sampling signal to the switching circuit 54, which then outputs the best sampling signal as the internal data signals INT_{CLK}.

In the automatic adjusting circuit 50 in FIG. 5, the delay circuit 52 can include a plurality of inverters. By passing the external clock signal EXT_{CLK} through different number of inverters, the sampling signals CLK_d1-CLK_dn having distinct phases can thus be generated. The synchronous storage units S1-Sn can include D-type flip-flops or registers capable of generating corresponding data latch signals D[1]-D[n] by latching data from the external data signal EXT_{DATA}. A truth table is stored in the decoder 56 for comparing the values of the data latch signals D[1]-D[n] as so to determine a best sampling signal from the sampling signals CLK_d1-CLK_dn.

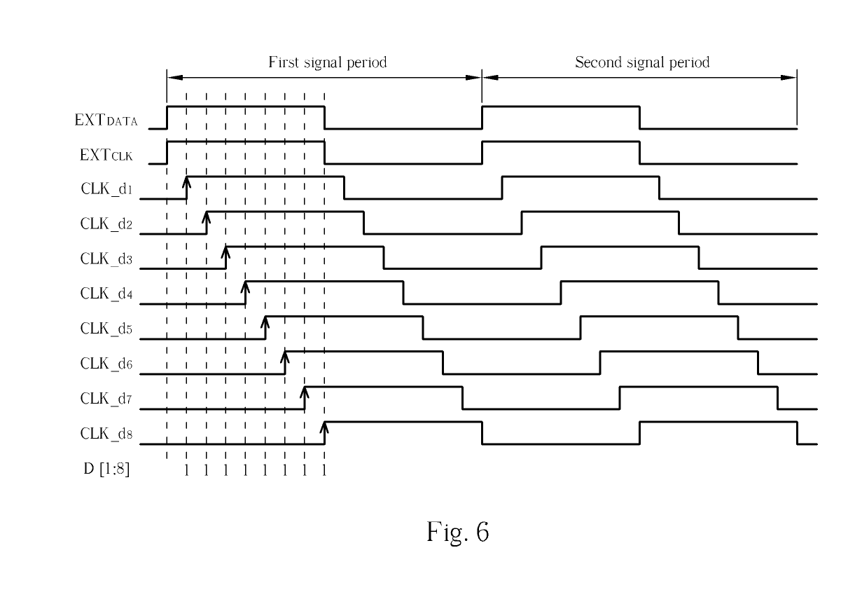

References are made to FIGS. 6-21 for waveforms illustrating the present driving methods capable of automatic de-skewing. In the embodiments shown in FIGS. 6-21, the delay circuit 52 generates 8 sampling signals CLK_d1-CLK_d8 having distinct phases based on the external clock signal EXT_{CLK}. The phase differences between the external clock signal EXT_{CLK} and the sampling signals CLK_d1-CLK_d8 are 1/16- 16/16 of a signal period, respectively.

FIG. 6 shows the result after latching data from the external data signal EXT_{DATA} at the signal triggering edges of the sampling signals CLK_d1-CLK_d8 when the external data signal EXT_{DATA} and the external clock signal EXT_{CLK} received by a source driver of the LCD devices 30 or 40 have a first phase relationship (zero phase difference). At the respective signal rising edges of the sampling signals CLK_d1-CLK_d8 during a first signal period, data sampled from the external clock signal EXT_{CLK} are represented by data latch signals D[1:8] equal to [111111111]. In this embodiment, the best sampling point is defined as the center of the data stable time of the external data signal EXT_{DATA}. Therefore, when the external data signal EXT_{DATA} and the external clock signal EXT_{CLK} received by a source driver have zero phase difference, the best sampling signal is the signal rising edge of the sampling signal CLK_d4.

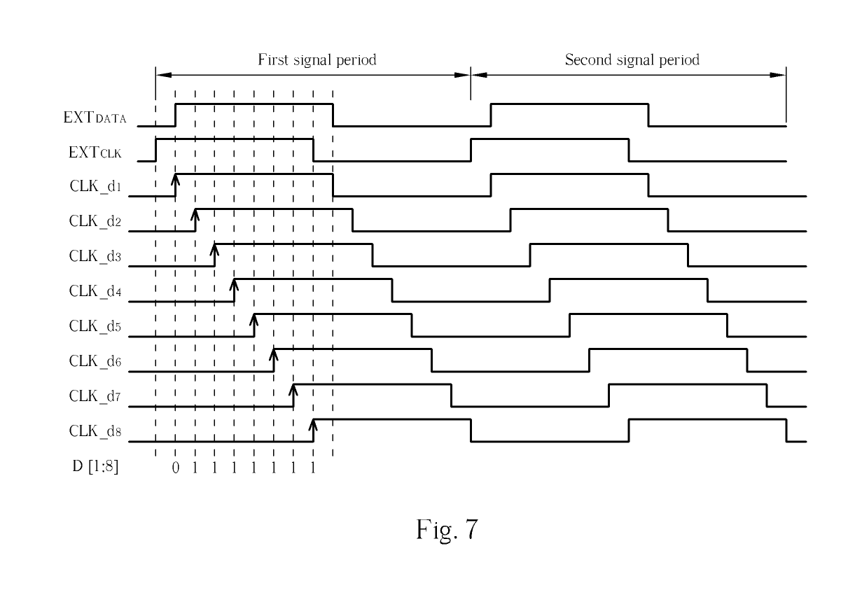

FIG. 7 shows the result after latching data from the external data signal EXT_{DATA} at the signal triggering edges of the sampling signals CLK_d1-CLK_d8 when the external data signal EXT_{DATA} and the external clock signal EXT_{CLK} received by a source driver of the LCD devices 30 or 40 have a second phase relationship (phase difference of 1/16 signal period). At the respective signal rising edges of the sampling signals CLK_d1-CLK_d8 during the first signal period, data sampled from the external data signal EXT_{DATA} are represented by data latch signals D[1:8] equal to [011111111]. In this embodiment, the best sampling point is also defined as the center of the data stable time of the external data signal EXT_{DATA}. Therefore, when the external data signal EXT_{DATA} and the external clock signal EXT_{CLK} received by a source driver have a phase difference of 1/16 signal period, the best sampling signal is the signal rising edge of the sampling signal CLK_d5.

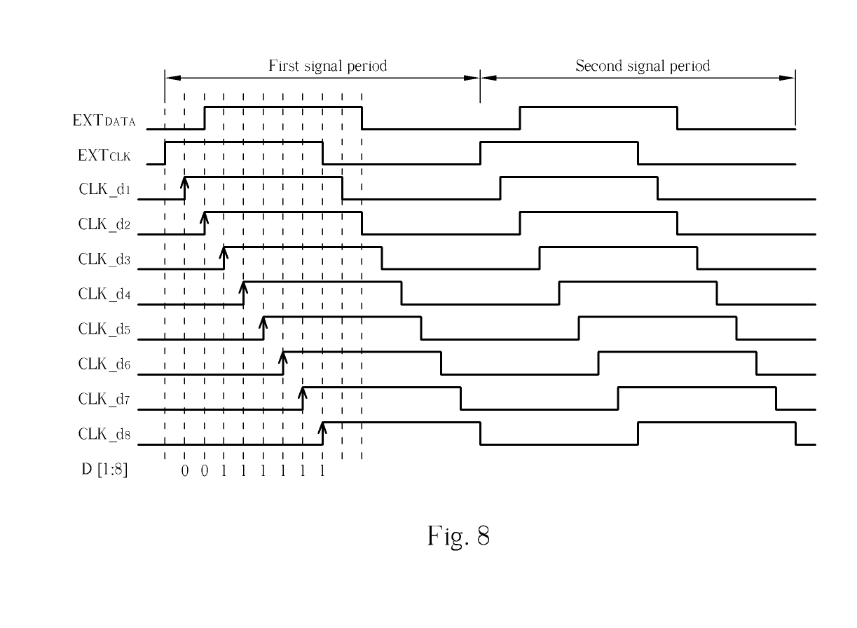

FIG. 8 shows the result after latching data from the external data signal EXT_{DATA} at the signal triggering edges of the sampling signals CLK_d1-CLK_d8 when the external data signal EXT_{DATA} and the external clock signal EXT_{CLK} received by a source driver of the LCD devices 30 or 40 have a third phase relationship (phase difference of 2/16 signal period). At the respective signal rising edges of the sampling signals CLK_d1-CLK_d8 during the first signal period, data sampled from the external data signal EXT_{DATA} are represented by data latch signals D[1:8] equal to [001111111]. In this embodiment, the best sampling point is also defined as the center of the data stable time of the external data signal EXT_{DATA}. Therefore, when the external data signal EXT_{DATA} and the external clock signal EXT_{CLK} received by a source driver have a phase difference of 2/16 signal period, the best sampling signal is the signal rising edge of the sampling signal CLK_d6.

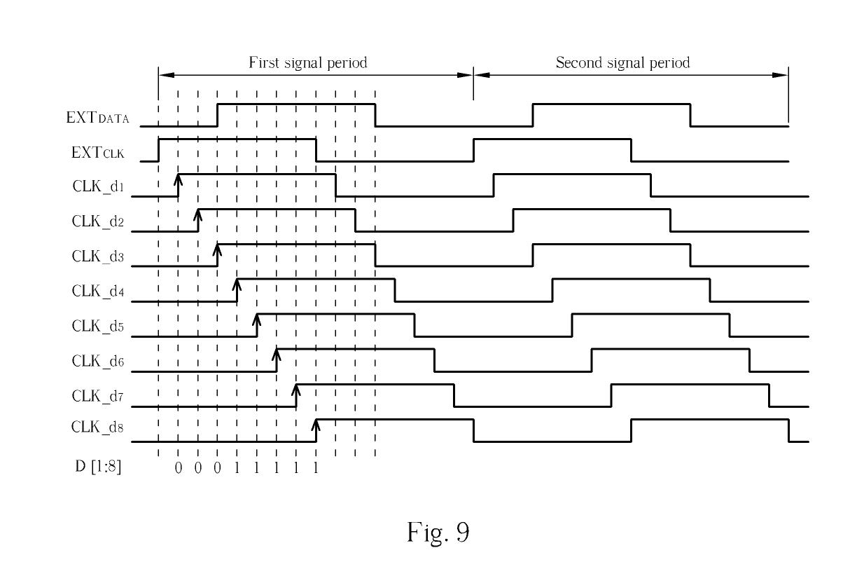

FIG. 9 shows the result after latching data from the external data signal EXT_{DATA} at the signal triggering edges of the sampling signals CLK_d1-CLK_d8 when the external data signal EXT_{DATA} and the external clock signal EXT_{CLK} received by a source driver of the LCD devices 30 or 40 have a fourth phase relationship (phase difference of 3/16 signal period). At the respective signal rising edges of the sampling signals CLK_d1-CLK_d8 during the first signal period, data sampled from the external data signal EXT_{DATA} are represented by data latch signals D[1:8] equal to [000111111]. In this embodiment, the best sampling point is also defined as the center of the data stable time of the external data signal EXT_{DATA}. Therefore, when the external data signal EXT_{DATA} and the external clock signal EXT_{CLK} received by a source driver have a phase difference of 3/16 signal period, the best sampling signal is the signal rising edge of the sampling signal CLK_d7.

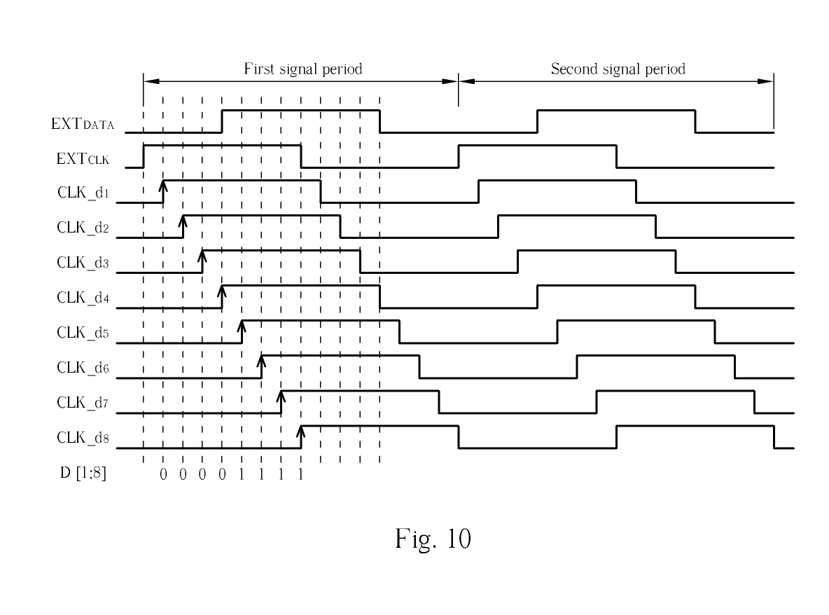

FIG. 10 shows the result after latching data from the external data signal EXT_{DATA} at the signal triggering edges of the sampling signals CLK_d1-CLK_d8 when the external data signal EXT_{DATA} and the external clock signal EXT_{CLK} received by a source driver of the LCD devices 30 or 40 have a fifth phase relationship (phase difference of 4/16 signal period). At the respective signal rising edges of the sampling signals CLK_d1-CLK_d8 during the first signal period, data sampled from the external data signal EXT_{DATA} are represented by data latch signals D[1:8] equal to [000011111]. In this embodiment, the best sampling point is also defined as the center of the data stable time of the external data signal EXT_{DATA}. Therefore, when the external data signal EXT_{DATA} and the external clock signal EXT_{CLK} received by a source driver have a phase difference of 4/16 signal period, the best sampling signal is the signal rising edge of the sampling signal CLK_d8.

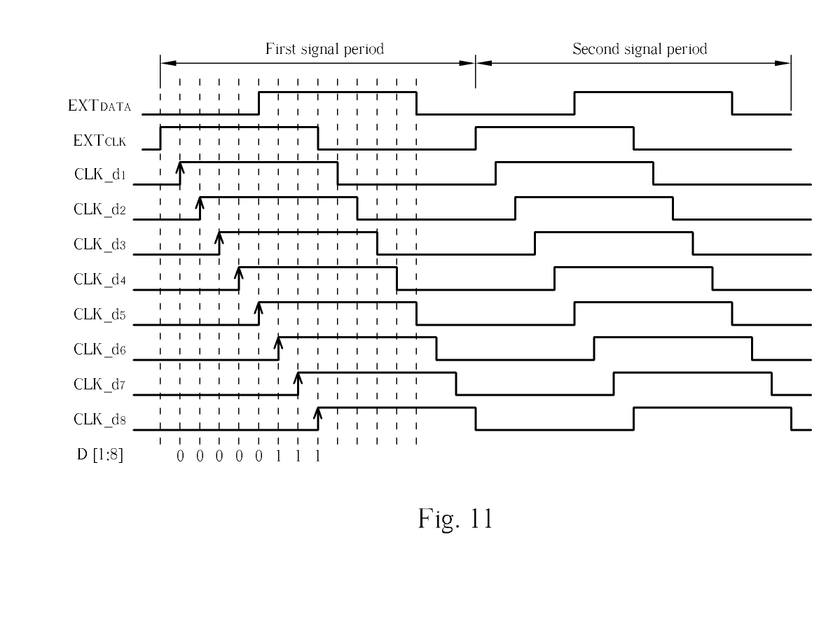

FIG. 11 shows the result after latching data from the external data signal EXT_{DATA} at the signal triggering edges of the sampling signals CLK_d1-CLK_d8 when the external data signal EXT_{DATA} and the external clock signal EXT_{CLK} received by a source driver of the LCD devices 30 or 40 have a sixth phase relationship (phase difference of 5/16 signal period). At the respective signal rising edges of the sampling signals CLK_d1-CLK_d8 during the first signal period, data sampled from the external data signal EXT_{DATA} are represented by data latch signals D[1:8] equal to [000001111]. In this embodiment, the best sampling point is also defined as the center of the data stable time of the external data signal EXT_{DATA}. Therefore, when the external data signal EXT_{DATA} and the external clock signal EXT_{CLK} received by a source driver have a phase difference of 5/16 signal period, the best sampling signal is the signal falling edge of the sampling signal CLK_d1.

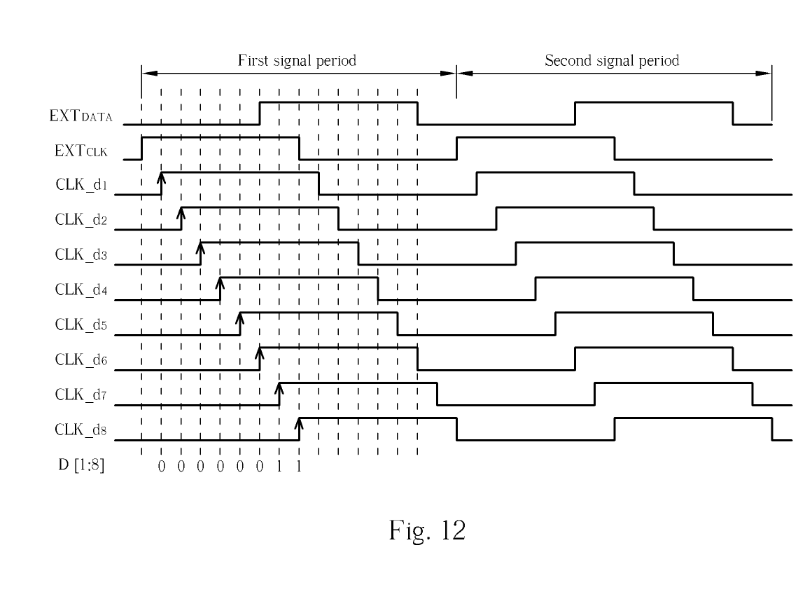

FIG. 12 shows the result after latching data from the external data signal EXT_{DATA} at the signal triggering edges of the sampling signals CLK_d1-CLK_d8 when the external data signal EXT_{DATA} and the external clock signal EXT_{CLK} received by a source driver of the LCD devices 30 or 40 have a seventh phase relationship (phase difference of 6/16 signal period). At the respective signal rising edges of the sampling signals CLK_d1-CLK_d8 during the first signal period, data sampled from the external data signal EXT_{DATA} are represented by data latch signals D[1:8] equal to [00000011]. In this embodiment, the best sampling point is also defined as the center of the data stable time of the external data signal EXT_{DATA}. Therefore, when the external data signal EXT_{DATA} and the external clock signal EXT_{CLK} received by a source driver have a phase difference of 6/16 signal period, the best sampling signal is the signal falling edge of the sampling signal CLK_d2.

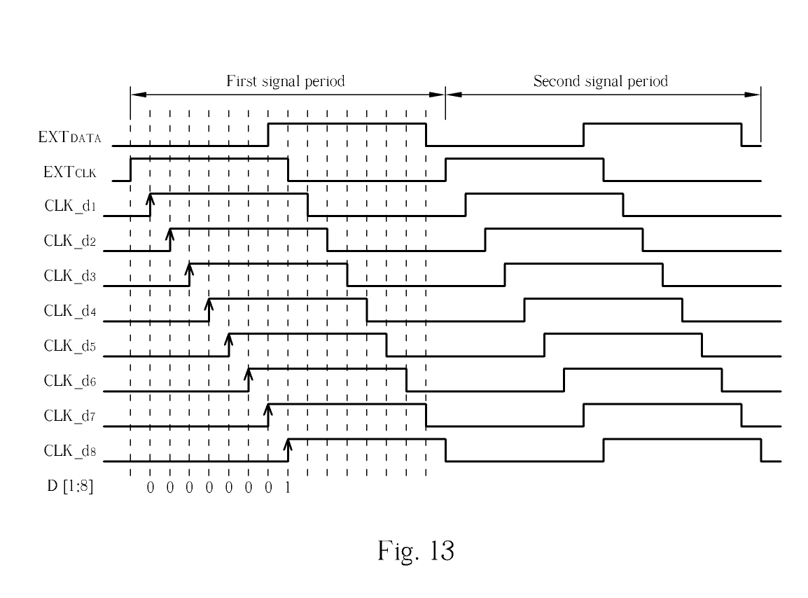

FIG. 13 shows the result after latching data from the external data signal EXT_{DATA} at the signal triggering edges of the sampling signals CLK_d1-CLK_d8 when the external data signal EXT_{DATA} and the external clock signal EXT_{CLK} received by a source driver of the LCD devices 30 or 40 have an eighth phase relationship (phase difference of 7/16 signal period). At the respective signal rising edges of the sampling signals CLK_d1-CLK_d8 during the first signal period, data sampled from the external data signal EXT_{DATA} are represented by data latch signals D[1:8] equal to [00000001]. In this embodiment, the best sampling point is also defined as the center of the data stable time of the external data signal EXT_{DATA}. Therefore, when the external data signal EXT_{DATA} and the external clock signal EXT_{CLK} received by a source driver have a phase difference of 7/16 signal period, the best sampling signal is the signal falling edge of the sampling signal CLK_d3.

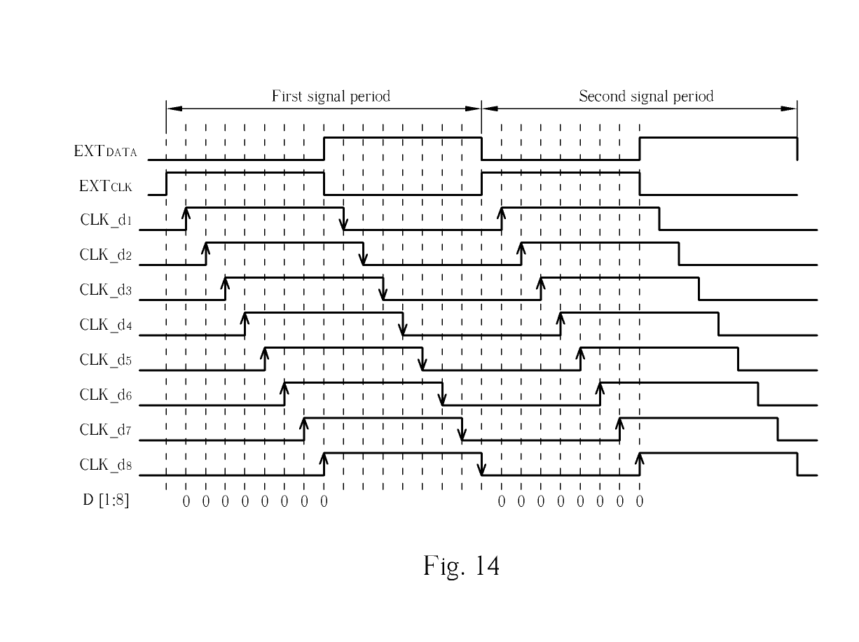

FIG. 14 shows the result after latching data from the external data signal EXT_{DATA} at the signal triggering edges of the sampling signals CLK_d1-CLK_d8 when the external data signal EXT_{DATA} and the external clock signal EXT_{CLK} received by a source driver of the LCD devices 30 or 40 have a ninth phase relationship (phase difference of 8/16 signal period). At the respective signal rising edges of the sampling signals CLK_d1-CLK_d8 during the first signal period, data sampled from the external data signal EXT_{DATA} are represented by data latch signals D[1:8] equal to [00000000]. In this embodiment, the best sampling point is also defined as the center of the data stable time of the external data signal EXT_{DATA}. Therefore, when the external data signal EXT_{DATA} and the external clock signal EXT_{CLK} received by a source driver have a phase difference of 8/16 signal period, the best sampling signal is the signal falling edge of the sampling signal CLK_d4.

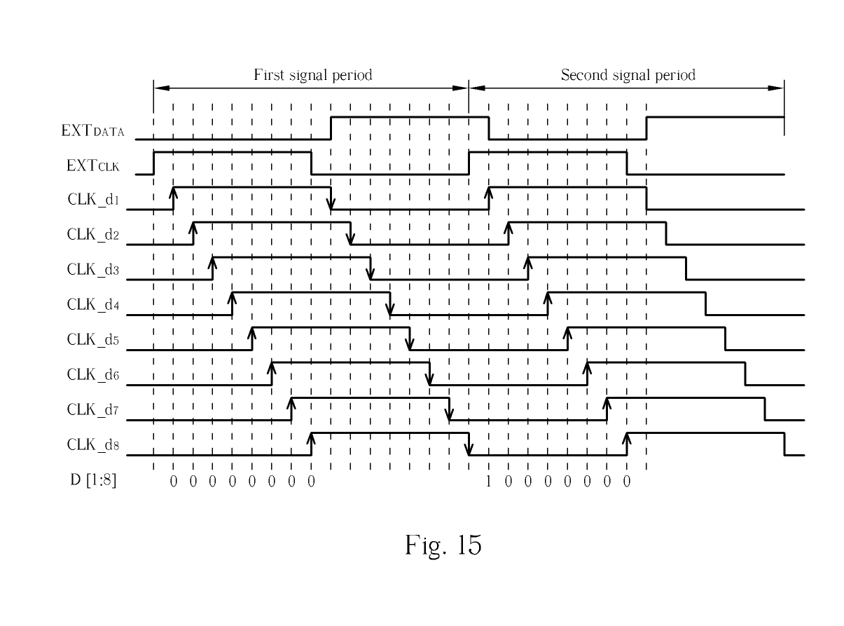

FIG. 15 shows the result after latching data from the external data signal EXT_{DATA} at the signal triggering edges of the sampling signals CLK_d1-CLK_d8 when the external data signal EXT_{DATA} and the external clock signal EXT_{CLK} received by a source driver of the LCD devices 30 or 40 have a tenth phase relationship (phase difference of 9/16 signal period). At the respective signal rising edges of the sampling signals CLK_d1-CLK_d8 during a second signal period, data sampled from the external data signal EXT_{DATA} are represented by data latch signals D[1:8] equal to [10000000]. In this embodiment, the best sampling point is also defined as the center of the data stable time of the external data signal EXT_{DATA}. Therefore, when the external data signal EXT_{DATA} and the external clock signal EXT_{CLK} received by a source driver have a phase difference of 9/16 signal period, the best sampling signal is the signal falling edge of the sampling signal CLK_d5.

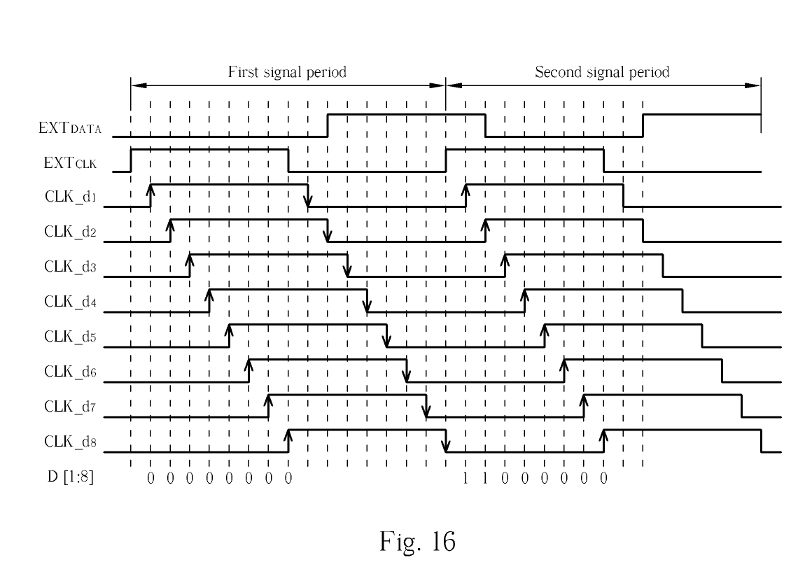

FIG. 16 shows the result after latching data from the external data signal EXT_{DATA} at the signal triggering edges of the sampling signals CLK_d1-CLK_d8 when the external data signal EXT_{DATA} and the external clock signal EXT_{CLK} received by a source driver of the LCD devices 30 or 40 have an eleventh phase relationship (phase difference of 10/16 signal period). At the respective signal rising edges of the sampling signals CLK_d1-CLK_d8 during the second signal period, data sampled from the external data signal EXT_{DATA} are represented by data latch signals D[1:8] equal to [11000000]. In this embodiment, the best sampling point is also defined as the center of the data stable time of the external data signal EXT_{DATA}. Therefore, when the external data signal EXT_{DATA} and the external clock signal EXT_{CLK} received by a source driver have a phase difference of 10/16 signal period, the best sampling signal is the signal falling edge of the sampling signal CLK_d6.

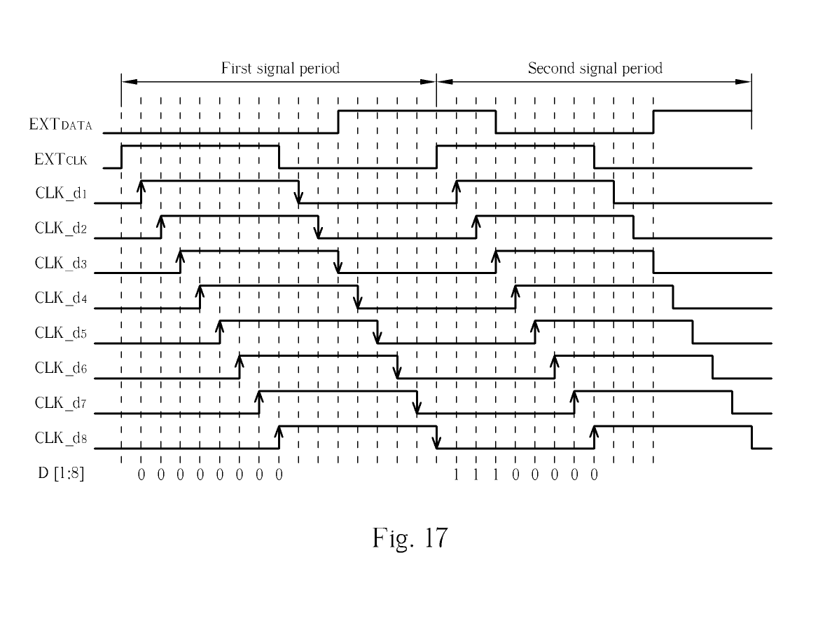

FIG. 17 shows the result after latching data from the external data signal EXT_{DATA} at the signal triggering edges of the sampling signals CLK_d1-CLK_d8 when the external data signal EXT_{DATA} and the external clock signal EXT_{CLK} received by a source driver of the LCD devices 30 or 40 have a twelfth phase relationship (phase difference of 11/16 signal period). At the respective signal rising edges of the sampling signals CLK_d1-CLK_d8 during the second signal period, data sampled from the external data signal EXT_{DATA} are represented by data latch signals D[1:8] equal to [11100000]. In this embodiment, the best sampling point is also defined as the center of the data stable time of the external data signal EXT_{DATA}. Therefore, when the external data signal EXT_{DATA} and the external clock signal EXT_{CLK} received by a source driver have a phase difference of 11/16 signal period, the best sampling signal is the signal falling edge of the sampling signal CLK_d7.

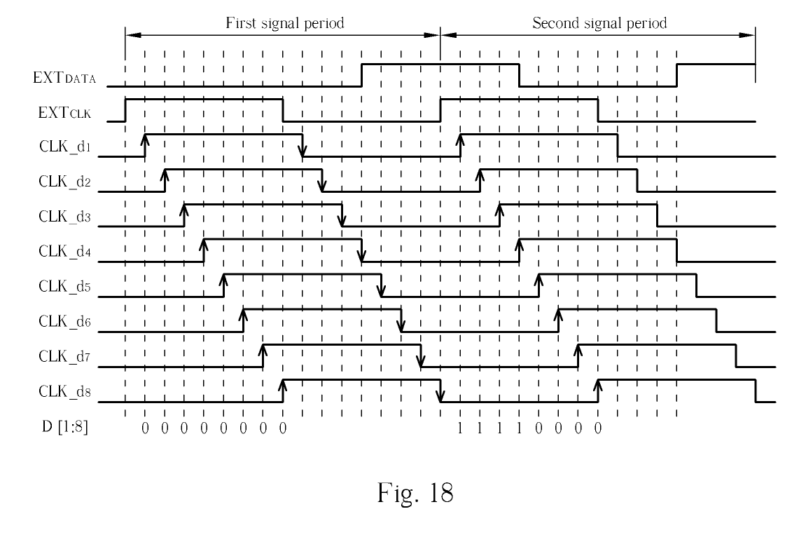

FIG. 18 shows the result after latching data from the external data signal EXT_{DATA} at the signal triggering edges of the sampling signals CLK_d1-CLK_d8 when the external data signal EXT_{DATA} and the external clock signal EXT_{CLK} received by a source driver of the LCD devices 30 or 40 have a thirteenth phase relationship (phase difference of 12/16 signal period). At the respective signal rising edges of the sampling signals CLK_d1-CLK_d8 during the second signal period, data sampled from the external data signal EXT_{DATA} are represented by data latch signals D[1:8] equal to [11110000]. In this embodiment, the best sampling point is also defined as the center of the data stable time of the external data signal EXT_{DATA}. Therefore, when the external data signal EXT_{DATA} and the external clock signal EXT_{CLK} received by a source driver have a phase difference of 12/16 signal period, the best sampling signal is the signal falling edge of the sampling signal CLK_d8.

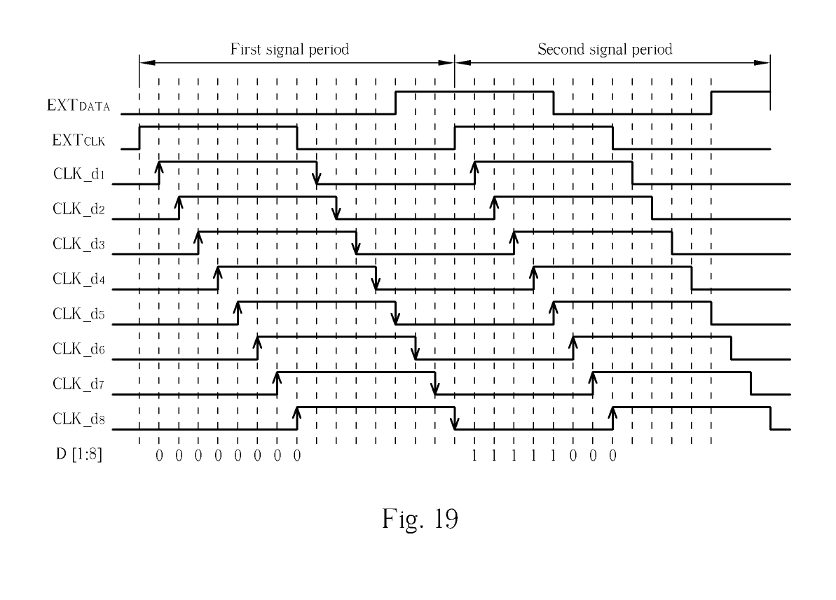

FIG. 19 shows the result after latching data from the external data signal EXT_{DATA K} at the signal triggering edges of the sampling signals CLK_d1-CLK_d8 when the external data signal EXT_{DATA} and the external clock signal EXT_{CLK} received by a source driver of the LCD devices 30 or 40 have a fourteenth phase relationship (phase difference of 13/16 signal period). At the respective signal rising edges of the sampling signals CLK_d1-CLK_d8 during the second signal period, data sampled from the external data signal EXT_{DATA} are represented by data latch signals D[1:8] equal to [11111000]. In this embodiment, the best sampling point is also defined as the center of the data stable time of the external data signal EXT_{DATA}. Therefore, when the external data signal EXT_{DATA} and the external clock signal EXT_{CLK} received by a source driver have a phase difference of 13/16 signal period, the best sampling signal is the signal rising edge of the sampling signal CLK_d1.

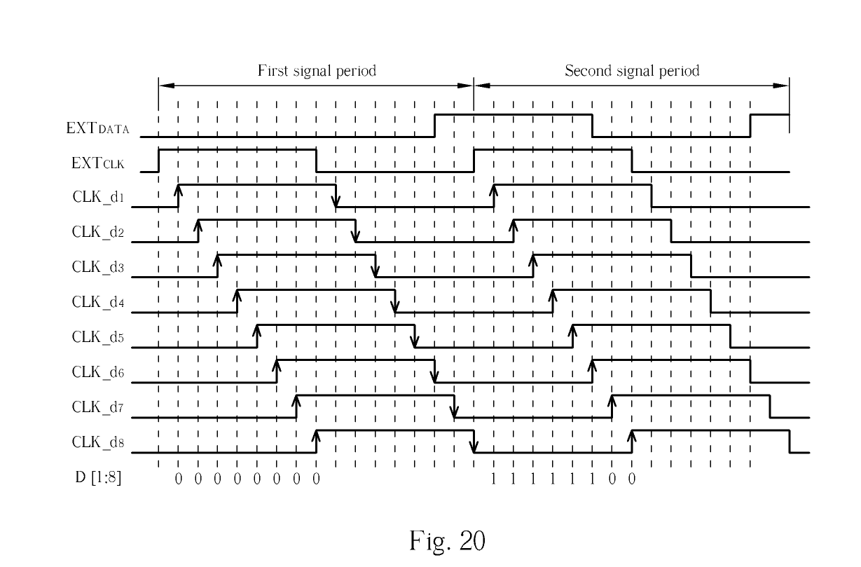

FIG. 20 shows the result after latching data from the external data signal EXT_{DATA} at the signal triggering edges of the sampling signals CLK_d1-CLK_d8 when the external data signal EXT_{DATA} and the external clock signal EXT_{CLK} received by a source driver of the LCD devices 30 or 40 have a fifteenth phase relationship (phase difference of 14/16 signal period). At the respective signal rising edges of the sampling signals CLK_d1-CLK_d8 during the second signal period, data sampled from the external data signal EXT_{DATA} are represented by data latch signals D[1:8] equal to [11111100]. In this embodiment, the best sampling point is also defined as the center of the data stable time of the external data signal EXT_{DATA}. Therefore, when the external data signal EXT_{DATA} and the external clock signal EXT_{CLK} received by a source driver have a phase difference of 14/16 signal period, the best sampling signal is the signal rising edge of the sampling signal CLK_d2.

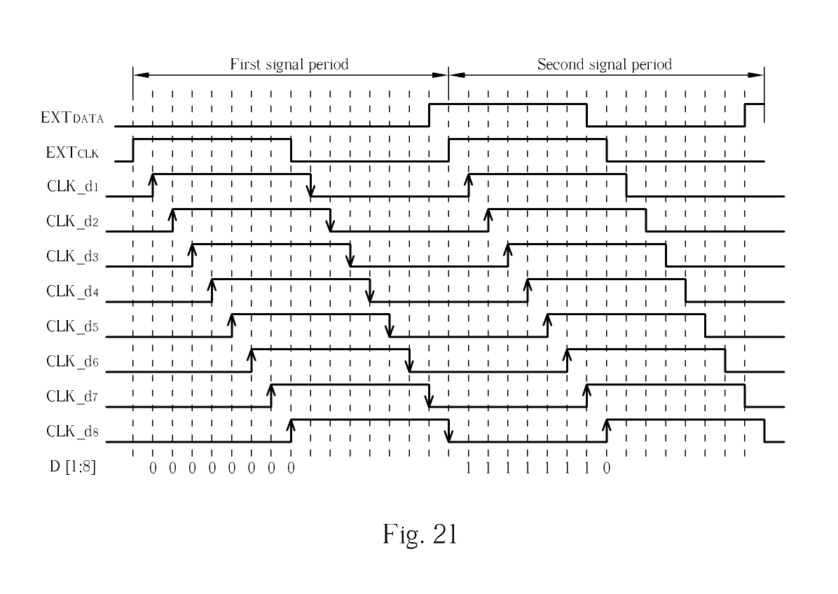

FIG. 21 shows the result after latching data from the external data signal EXT_{DATA} at the signal triggering edges of the sampling signals CLK_d1-CLK_d8 when the external data signal EXT_{DATA} and the external clock signal EXT_{CLK} received by a source driver of the LCD devices 30 or 40 have a sixteenth phase relationship (phase difference of 15/16 signal period). At the respective signal rising edges of the sampling signals CLK_d1-CLK_d8 during the second signal period, data sampled from the external data signal EXT_{DATA} are represented by data latch signals D[1:8] equal to [11111110]. In this embodiment, the best sampling point is also defined as the center of the data stable time of the external data signal EXT_{DATA}. Therefore, when the external data signal EXT_{DATA} and the external clock signal EXT_{CLK} received by a source driver have a phase difference of 15/16 signal period, the best sampling signal is the signal rising edge of the sampling signal CLK_d3.

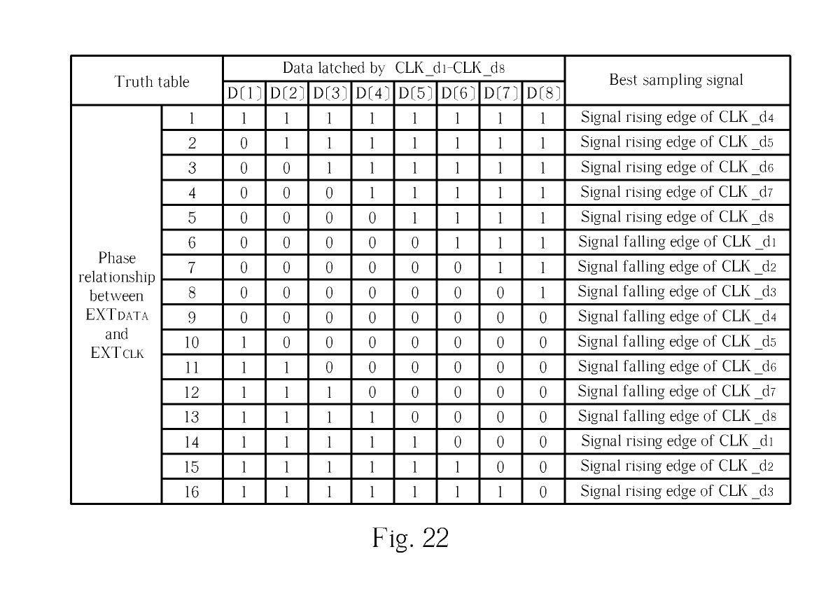

In the present invention, the best sampling point is can be defined in many ways (such as the center of the data stable time) and a corresponding truth table can be provided. Based on the truth table, the decoder 56 can determine the best sampling signal and generate the corresponding switch control signal. Reference is made to FIG. 22 depicting a truth table according to the present invention. As illustrated in the embodiments of FIGS. 5-21, as the phase differences between the external data signal EXT_{DATA} and the external clock signal EXT_{CLK} vary, data latched by the sampling signals CLK_d1-CLK_d8 can have 16 different results, each corresponding to a best sampling signal according the defined best sampling point (such as the center of the data stable time). The decoder 56 can then output corresponding switch control signals to the switching circuit 52 based on the truth table of FIG. 22, thereby providing the best sampling signal as the internal clock signal INT_{CLK}.

In the present invention, the automatic adjusting circuit and the source driver can be two independent ICs or integrated as a same IC. The present invention can be applied to LCD devices or other types of display systems.

In the present invention, a plurality of sampling signals having distinct phases are generated by adjusting the phase of the external clock signal generated by the timing controller. Based on the sampling signals, the data latch signals are generated by latching the external data signal and sent to the decoder. By comparing the data latch signals with the truth table stored in the decider, the best sampling signal can be determined. Therefore, even if the external data signals and the external clock signals received by different source drivers encounter different degrees of signal delays, possibly due to unmatched toggle rates, ground shielding, and output driving capabilities, each source driver can perform de-skewing using its delay circuit and generates the correct driving voltage.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display system capable of automatic de-skewing comprising:
a display panel for displaying images;
a timing controller for generating an external data signal and an external clock signal;
an automatic adjusting circuit coupled to the timing controller for adjusting phases of the external data signal and the external clock signal and thereby generating a corresponding internal data signal and a corresponding internal clock signal having signal triggering edges aligned to ranges of the internal data signal where data can be correctly sampled; and
a driving circuit coupled to the automatic adjusting circuit and the display panel for generating driving voltages for the display panel based on the internal data signal and internal clock signal received from the automatic adjusting circuit.

2. The display system of claim 1 wherein the automatic adjusting circuit comprises:
a delay circuit coupled to the timing controller for adjusting the phase of the external clock signal and thereby generating a plurality of sampling signals having distinct phases.

3. The display system of claim 2 wherein the delay circuit includes a plurality of inverters.

4. The display system of claim 2 wherein the automatic adjusting circuit further comprises:
a plurality of synchronous storage units coupled to the timing controller and the delay circuit, each synchronous storage unit receiving the external data signal and a corresponding sampling signal and thereby generating a corresponding data latch signal by sampling the external data signal based on the received sampling signal.

5. The display system of claim 4 wherein each synchronous storage unit includes a D-type flip-flop or a register.

6. The display system of claim 4 wherein the automatic adjusting circuit further comprises:
a decoder coupled to the plurality of synchronous storage units for receiving the data latch signal generated by each synchronous storage unit, and thereby generating a switch control signal based on the data latch signals generated by the synchronous storage units.

7. The display system of claim 6 wherein the automatic adjusting circuit further comprises:
a switching circuit coupled to the delay circuit and the decoder for selecting a sampling signal from the plurality of sampling signals based on the switch control signal received from the decoder and outputting selected sampling signal as the internal clock signal.

8. The display system of claim 1 wherein the automatic adjusting circuit and the driving circuit are integrated as a same integrated circuit.

9. The display system of claim 1 wherein the automatic adjusting circuit and the driving circuit are two independent integrated circuits.

10. The display system of claim 1 wherein the display panel includes a liquid crystal display (LCD) panel.

11. The display system of claim 1 wherein the driving circuit includes a source driver of an LCD panel.

12. A driving method capable of automatic de-skewing including the following steps:
(a) receiving an external data signal and an external clock signal;
(b) generating a plurality of sampling signals by adjusting a phase of the external clock signal;
(c) generating a plurality of corresponding data latch signals by sampling the external data signal based on the plurality of sampling signals;
(d) selecting a best sampling signal from the plurality of the sampling signals based on the plurality of data latch signals; and
(e) outputting the best sampling signal as an internal clock signal.

13. The method of claim 12 wherein step (d) includes selecting a best sampling signal having a signal rising edge aligned to a center of data stable time of the external data signal from the plurality of the sampling signals.

14. The method of claim 12 wherein step (d) includes selecting a best sampling signal having a signal falling edge aligned to a center of data stable time of the external data signal from the plurality of the sampling signals.

15. The method of claim 12 further comprising:
generating the external data signal and the external clock signal.
